(19) United States
(12) Patent Application Publication
(10) Pub. No.: US 2017/0087662 A1
(43) Pub. Date: Mar. 30, 2017

(54) Tooling For Ultrasonic Tube Sealer For Sealing An End Portion Of A Tube With A Double Seal

(71) Applicant: Branson Ultrasonics Corporation, Danbury, CT (US)

(72) Inventors: Guillermo COTO, Monroe, CT (US); Michael DAVIS, Beacon Falls, CT (US)

(73) Assignee: Branson Ultrasonics Corporation, Danbury, CT (US)

(21) Appl. No.: 15/258,403

(22) Filed: Sep. 7, 2016

Related U.S. Application Data
(60) Provisional application No. 62/234,830, filed on Sep. 30, 2015.

(51) Int. Cl. B23K 20/10

(52) U.S. Cl. CPC B23K 20/106

(57) ABSTRACT

An ultrasonic horn tip for an ultrasonic horn of an ultrasonic tube sealer has a body with a plurality of sides. At least one of the sides has a pair of spaced apart weld tools configured to contact a portion of a tube being sealed in at least two places along the tube that are spaced from each other when the pair of weld tools contact the tube. An anvil for an ultrasonic tube sealer includes a body having a pair of spaced apart weld pads configured to contact a portion of a tube being sealed in at two places along the tube that are spaced from each other when the anvil contact the tube. A tooling kit for an ultrasonic tube sealer includes the foregoing ultrasonic horn tip and anvil.

### CROSS-REFERENCE TO RELATED APPLICATIONS

This application claims the benefit of U.S. Provisional Application No. 62/234,830 filed on Sep. 30, 2015. The entire disclosure of the above application is incorporated herein by reference.

### FIELD

The present disclosure relates to ultrasonic tube sealers and more particularly, to tooling used in ultrasonic tube sealers to seal tubes.

### BACKGROUND

This section provides background information related to the present disclosure which is not necessarily prior art.

A model of a typical ultrasonic tube sealer 100 is shown in FIG. 1. Typical components of ultrasonic tube sealer 100 include an ultrasonic transducer 102, a booster 104, and an ultrasonic horn 106. Electrical energy from a power supply 101 at a frequency of 20-60 kHz is converted to mechanical energy by the ultrasonic transducer 102. The mechanical energy converted in the ultrasonic transducer 102 is transmitted to a tube 108 to be sealed through the booster 104 and the ultrasonic horn 106. The booster 104 and the ultrasonic horn 106 perform the functions of transmitting the mechanical energy as well as transforming mechanical vibrations from the ultrasonic transducer 102 by a gain factor.

The mechanical vibration that results on an ultrasonic horn tip 110 is the motion that performs the task of sealing the tube 108. Ultrasonic horn tip 110 illustratively includes one or more forming tools (not shown) on sides of ultrasonic horn tip 110. A portion of the tube 108 to be sealed, typically an end portion 112, is placed between ultrasonic horn tip 110 and an anvil tip 114 of an anvil 116 and supported by anvil tip 114. Anvil tip 114 illustratively includes a forming tool (not shown). The forming tool of ultrasonic horn tip 110 is brought into contact with end portion 112 of tube 108 pinching end portion 112 between the forming tool of ultrasonic horn tip 110 and the forming tool of anvil tip 114. Typically, ultrasonic horn tip 110 is brought to a pre-determined distance from anvil tip 114 so that there is a pre-set gap between the forming tools of ultrasonic horn tip 110 and anvil tip 114 in which the end portion 112 of tube 108 to be sealed is situated. Ultrasonic vibrations are applied via the ultrasonic horn tip 110 to end portion 112 of tube 108. The ultrasonic vibrations generate heat to bond the material of the end portion 112 of tube 108 together where end portion 112 is pinched between the forming tools of ultrasonic horn tip 110 and anvil tip 114. The forming tools of ultrasonic horn tip 110 and anvil tip 114 also form the end portion 112 of tube 108, such as by cutting it. The electrical energy provided by power supply 101 is then stopped and the end portion 112 of tube 108 held closed between the forming tools of ultrasonic horn tip 110 and anvil tip 114 for a brief period of time. An examples of such a prior art ultrasonic tube sealer is the Branson Ultraseal® Ultrasonic Tube Welding System available from Branson Ultrasonics Corporation, Danbury, Conn.

Typically, the forming tools of ultrasonic horn tip 110 and the anvil tip 114 form the end portion 112 of the tube 108 to have a single seal.

### SUMMARY

In accordance with an aspect of the present disclosure an ultrasonic horn tip for an ultrasonic horn of an ultrasonic tube sealer has a body with a plurality of sides. At least one of the sides has a pair of spaced apart weld tools configured to contact a portion of a tube being sealed in at least two places along the tube that are spaced from each other when the pair of weld tools contact the tube. In an aspect, each weld tool is an axial member that extends axially along the side of the body that has the weld tool. In an aspect, each weld tool has a convex outer surface. In an aspect, the ultrasonic horn tip includes a plurality of pairs of weld tools wherein at least opposed sides of the body each have a respective pair of the spaced apart weld tools. In an aspect, each side of the body that has the pair of weld tools includes a cut-off knife adjacent to a laterally outer side of one of the weld tools. In an aspect, the body is an integral part of an ultrasonic horn.

In accordance with an aspect of the present disclosure, an anvil for an ultrasonic tube sealer includes a body having a pair of spaced apart weld pads configured to contact a portion of a tube being sealed in at two places along the tube that are spaced from each other when the anvil contact the tube. In an aspect, each weld pad is an axial member that extends axially along the body of the anvil. In an aspect, each weld pad has a flat outer knurled surface. In an aspect, a laterally outer side of one of the weld pads has a cut-off edge.

In accordance with an aspect of the present disclosure, a tooling kit for an ultrasonic tube sealer includes the ultrasonic horn tip and anvil described above.

### DRAWINGS

The drawings described herein are for illustrative purposes only of selected embodiments and not all possible implementations, and are not intended to limit the scope of the present disclosure.

FIG. 1 is schematic view of a prior art ultrasonic tube sealer;

FIG. 2 is a perspective view of a portion of an ultrasonic tube sealer showing an ultrasonic horn tip and anvil tip in accordance with an aspect of the present disclosure;

FIG. 3 is an enlarged view of portion C of FIG. 2;

FIG. 4 is a perspective end view of FIG. 3;

FIG. 5 is a perspective view of the ultrasonic horn tip of FIGS. 2-4;

FIG. 6 is a perspective view of the anvil of FIGS. 2-4; and

FIG. 7 is a perspective view of a cut-off section of tube with a dual sealed end portion.

Corresponding reference numerals indicate corresponding parts throughout the several views of the drawings.

### DETAILED DESCRIPTION

Example embodiments will now be described more fully with reference to the accompanying drawings.

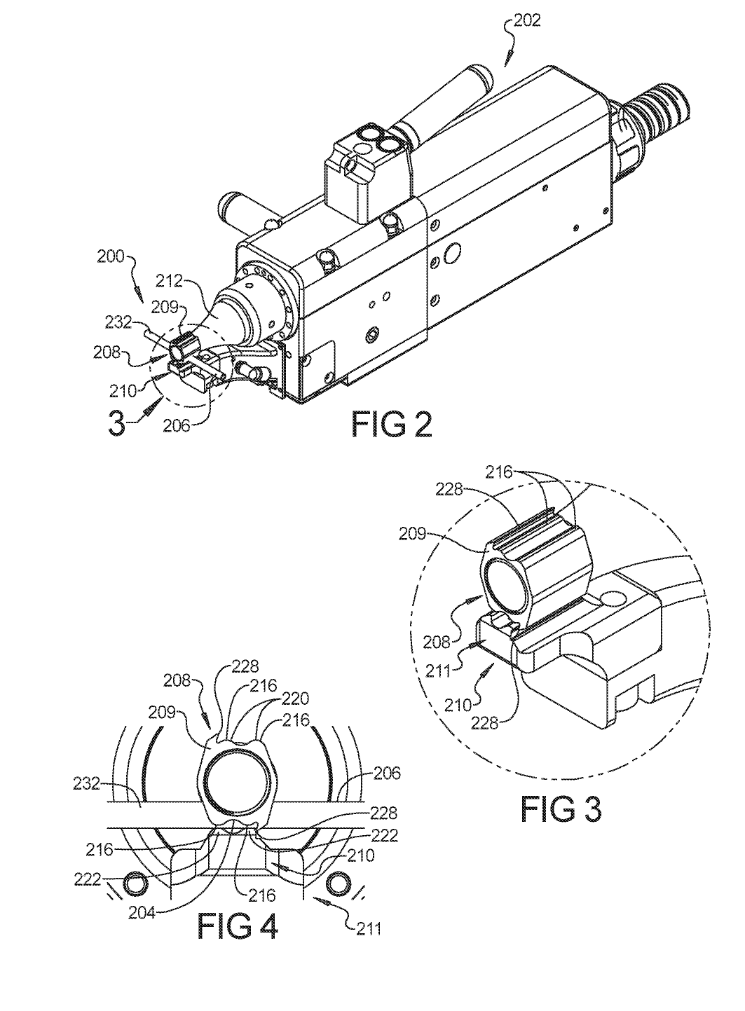

With reference to FIGS. 2-6, in accordance with an aspect of the present disclosure, tooling 200 for an ultrasonic tube sealer 202 is configured to seal an end portion 204 (FIG. 4) of a section 232 of tube 206 being sealed with a dual seal when end portion 204 is sealed. By a dual seal it is meant that end portion 204 is sealed in two places 224 (FIG. 7) that are spaced apart from each other. It should be understood that with the exception of tooling 200, ultrasonic tube sealer 202 has the same basic components as ultrasonic tube sealer 100 and operates in the same manner.

Tooling 200 includes an ultrasonic horn tip 208 and an anvil 210. In an aspect, tooling 200 is a tooling kit that includes ultrasonic horn tip 208 and anvil 210. Ultrasonic horn tip 208 is disposed on an ultrasonic horn 212 of ultrasonic tube sealer 202. In the example embodiment, ultrasonic horn tip 208 is a replaceable component and mounted on ultrasonic horn 212. It should be understood that ultrasonic horn tip 208 could be an integral part of ultrasonic horn tip 208.

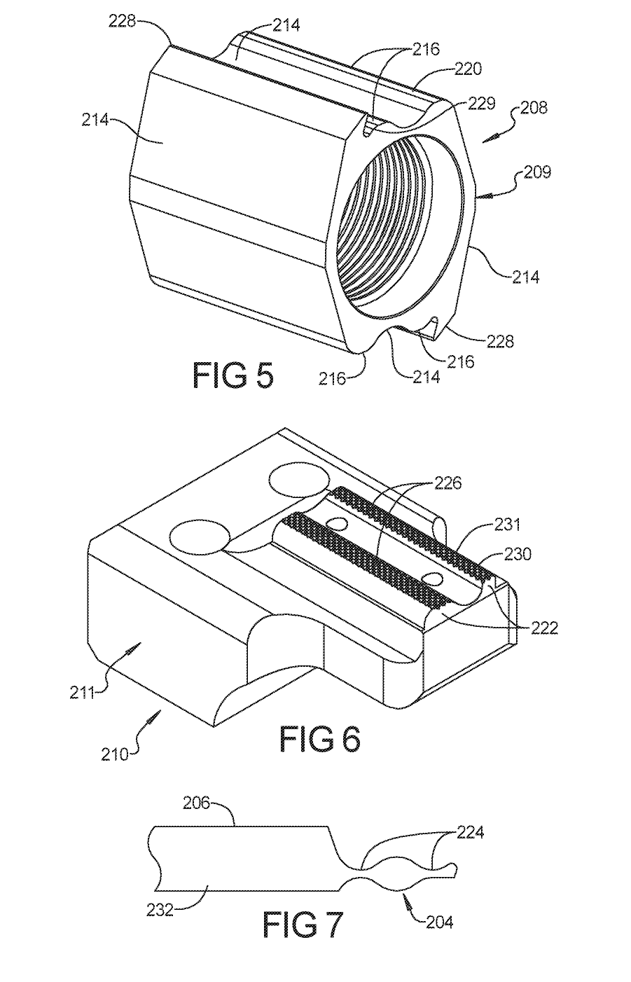

Ultrasonic horn tip 208 illustratively has a body 209 having a plurality of sides 214 (FIG. 5). At least one of sides 214 has a pair of spaced apart weld tools 216 (best shown in FIG. 5). Illustratively, ultrasonic horn tip 208 has pair of spaced apart weld tools 216 on two opposed sides 214. Illustratively, each weld tool 216 is an axial member that extends axially on the side 214 that has that weld tool 216 and has a convex outer surface 220. Anvil 210 has a body 211 having a pair of spaced apart weld pads 222 (best shown in FIG. 6) corresponding to and that cooperate with weld tools 216 to seal end portion 204 in two places 224 (FIG. 7) spaced from each other when end portion 204 is sealed. Illustratively weld pads 222 are axial members that extend axially on anvil 210 and have a have a flat outer knurled surface 226. Each side 214 of ultrasonic horn tip 208 having the pair of weld tools 216 also has a cut-off knife 228 adjacent to a laterally outer side 229 (FIG. 5) of one of the weld tools 216. A laterally outer side 231 (FIG. 6) of the weld pad 222 corresponding to the weld tool 216 to which cut-off knife 228 is adjacent has a cut-off edge 230 (FIG. 6) that cooperates with cut-off knife 228 to cut off a section 232 of tube 206 as end portion 204 is being sealed. The end portion 204 is thus an end portion of section 232 after it has been cut-off from the remainder of tube 206 and end portion 204 is dual sealed, that is, sealed in the two places 224.

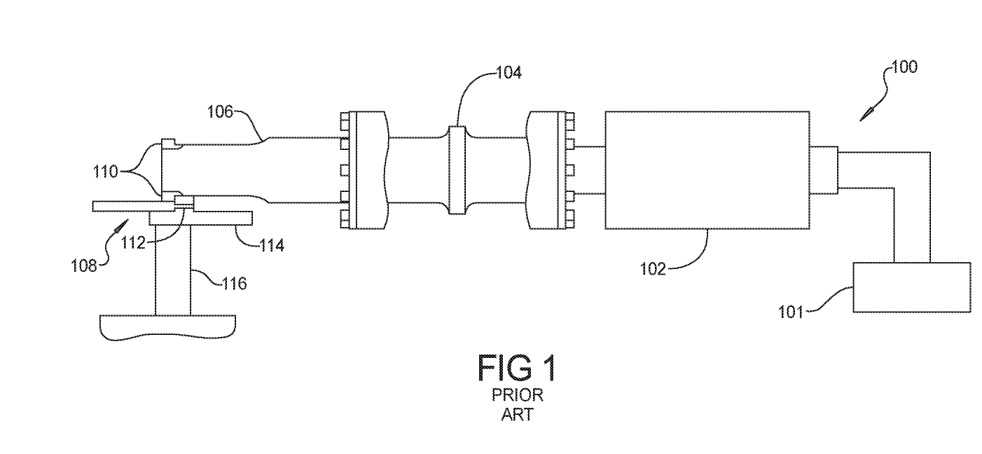

Ultrasonic tube sealer 202 operates in the same manner as ultrasonic tube sealer 100 to seal end portion 204. That is, one of the pairs of weld tools 216 of ultrasonic horn tip 208 and the weld pads 222 are brought together contacting end portion 204 of tube 206 at two places 224 that are spaced apart from each other and pinching end portion 204 between them at the two places 224. It should be understood that when the pair of weld tools 216 and the weld pads 222 pinch end portion 204 of tube 206 between them at spaced apart places 224, weld tools 216 and weld pads 222 are spaced from each other a predetermined distance, typically slightly less than two times a thickness of a wall of tube 206. Ultrasonic vibrations are applied via the ultrasonic horn tip 208 to end portion 204. The ultrasonic vibrations generate heat to bond the material of the end portion 204 together at the two places 224 where end portion 204 is pinched between the weld tools 216 of ultrasonic horn tip 208 and the weld pads 222 of anvil 210. Cut-off knife 228 of ultrasonic horn tip 208 in cooperation with cut-off edge 230 anvil 210 also cuts tube 206 to cut off section 232 with cut off section 232 having the end portion 204 sealed in the two places 224. The electrical energy provided by power supply 101 (FIG. 1) is then stopped and the end portion 204 held closed between weld tools 216 of ultrasonic horn tip 208 and weld pads 222 of anvil 210 for a brief period of time.

Illustratively, tube 206 extends laterally across weld tools 216 of ultrasonic horn tip 208 and weld pads 222. After each section 232 is cut off with a dual sealed end portion 204 and ultrasonic horn tip 208 opened (moved away from anvil 210, the tube 206 is then moved laterally an appropriate amount and the operation repeated to make another section 232 having its end portion 204 dual sealed.

Tube 206 is illustratively a copper or aluminum tube and the cut off sections 232 with their dual sealed end portions 204 are advantageously utilized in refrigeration systems, with one example being in cooling coils of air conditioning systems. The dual seal of end portion 204 of the cut off section 232 advantageously accommodates the close spaces between tubes in cooling cools of air conditioning units and the pressure experienced in the tubes. In this regard, the two places 224 where end portion sealed together are illustratively close together compared to other sealing operations such as acetylene flame torch brazing.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An ultrasonic horn tip for an ultrasonic horn of an ultrasonic tube sealer, comprising:
a body having a plurality of sides with at least one of the sides having a pair of spaced apart weld tools configured to contact a portion of a tube being sealed in at least two places along the tube that are spaced from each other when the pair of spaced apart weld tools contact the tube.

2. The ultrasonic horn tip of claim 1 wherein each weld tool is an axial member that extends axially along on the side of the body that has the weld tool.

3. The ultrasonic horn tip of claim 2 wherein each weld tool has a convex outer surface.

4. The ultrasonic horn tip of claim 1 including a plurality of pairs of spaced apart weld tools wherein at least opposed sides of the body each have a respective pair of the spaced apart weld tools.

5. The ultrasonic horn tip of claim 1 wherein each side of the body having the pair of spaced apart weld tools includes a cut-off knife adjacent to a laterally outer side of one of the weld tools.

6. The ultrasonic horn tip of claim 1 wherein the ultrasonic horn tip is removably mountable on an ultrasonic horn.

7. The ultrasonic horn tip of claim 1 wherein the ultrasonic horn tip is an integral part of an ultrasonic horn.

8. An anvil for an ultrasonic tube sealer, comprising:
a body having a pair of spaced apart weld pads configured to contact a portion of a tube being sealed in at two places along the tube that are spaced from each other when the anvil contact the tube.

9. The anvil of claim 8 wherein each weld pad is an axial member that extends axially along the body.

10. The anvil of claim 9 wherein each weld pad has a flat outer knurled surface.

11. The anvil of claim 8 wherein a laterally outer side of one of the weld pads has a cut-off edge.

12. A tooling kit for an ultrasonic tube sealer, comprising:
an ultrasonic horn tip;
an anvil;
the ultrasonic horn tip having a body having a plurality of sides with at least one of the sides having a pair of spaced apart weld tools;
the anvil having a pair of spaced apart weld pads; and
the pair of spaced apart weld tools and pair of spaced apart weld pads configured to contact opposites sides of a portion of a tube being sealed in at least two places along the tube that are spaced from each other when the ultrasonic horn tip and anvil are brought together with the tube between the pair of spaced apart weld tools and the pair of spaced apart weld pads.

13. The tooling kit of claim 12, wherein each weld tool is an axial member that extends axially along on the side of the body of the ultrasonic horn tip that has the weld tool and each weld pad is an axial member that extends axially along the body of the anvil.

14. The tooling kit of claim 13 wherein each weld tool has a convex outer surface and each weld pad has a flat knurled surface.

15. The tooling kit of claim 13 wherein the ultrasonic horn tip includes a plurality of pairs of spaced apart weld tools wherein at least opposed sides of the body of the ultrasonic horn tip each have a respective pair of the spaced apart weld tools.

16. The tooling kit of claim 12 wherein each side of the body of the ultrasonic horn tip having the pair of spaced apart weld tools includes a cut-off knife adjacent to a laterally outer side of one of the weld tools and a laterally outer side of the weld pad corresponding to the weld tool having the adjacent cut-off knife has a cut-off edge.

17. The tooling kit of claim 12 wherein the ultrasonic horn tip is removably mountable on an ultrasonic horn.

18. The tooling kit of claim 12 wherein the ultrasonic horn tip is an integral part of an ultrasonic horn.
